(19) United States
(12) Patent Application Publication
(10) Pub. No.: US 2007/0216538 A1
(43) Pub. Date: Sep. 20, 2007

(54) Method for Controlling a Media Content Processing Device, and a Media Content Processing Device

(75) Inventors: Eric Thelen, Aachen (DE); Dietrich Klakow, Saarbrucken (DE); Georg Kurz-Bauer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 10/599,882

(22) PCT Filed: Apr. 6, 2005
(86) PCT No.: PCT/IB05/51126

§ 371 Date: Oct. 12, 2006

(30) Foreign Application Priority Data
Apr. 15, 2004 (EP) 04101535.5

(51) Int. Cl. H04B 14/04

(52) U.S. Cl. 340/825.69; 381/104; 704/275

(57) ABSTRACT

The invention describes a method for controlling a media content processing device (1). It is thereby determined whether a media content (VI) to be processed is described by a pre-defined content descriptor (CD1, CD2) from a multitude of pre-defined content descriptors (CD1, CD2). A device control parameter (P11, P12, P21, P22) is automatically adjusted based on the content descriptor (CD1, CD2) which describes the media content (VI) to be processed. Then, the media content processing device (1) is automatically controlled, based on the device control parameter (P11, P12, P21, P22).

A method for controlling a media content processing device, and a media content processing device

The invention relates to a method for controlling a media content processing device and to a media content processing device. The invention relates in particular to the processing of media contents by means of media rendering devices such as televisions, personal computers or radios, or by media storage devices such as video recorders or audio recorders.

The term “media content” preferably describes radio and/or television programs such as movies, plays, news broadcasts, music chart shows, sports broadcasts, documentaries, etc., and can mean an entire unit, for example an entire movie or an entire news broadcast, or an excerpt of an entire unit, such as only the regional news segment of a news broadcast, or only the top three of the music charts. A media content may have any type of format, genre, duration and classification.

For many years now, content processing devices such as video recorders, televisions etc., have become an integral part of our daily lives. Even though technical parameters such as memory capacity, display features etc., have continually been improved upon throughout the years, a satisfactory level of ease with which such devices can be controlled has still not been attained.

Some promising suggestions have been made with a view to realising content processing devices as intelligent devices which can automatically control or organise themselves in such a way that the interaction between the user and device, necessary for control of the device, is considerably simplified or reduced. However, the suggested solutions often capitulate in the face of the fact that the devices usually used in a home environment generally do not dispose of the necessary processing power required for their realisation.

Therefore, an object of the present invention is to provide a method of controlling a content processing device, and to provide a content processing device, which allow comfortable interaction between the user and the content processing device.

The object of the invention is achieved by the features of the independent claims. Suitable and advantageous developments of the invention are defined by the features of the dependent claims. Further developments of the device claim according to the dependent claims of the method claim are also encompassed by the scope of the invention.

In a method according to the invention, it is determined whether a media content to be processed is described by a predefined content descriptor from among multitude of predefined content descriptors. A device control parameter is then adjusted, depending on the content descriptor describing the media content to be processed. A control of a media content processing device is carried out in accordance with the device control parameter.

The invention thus allows the control of a media content processing device to be automatically adapted to the content type of the media content being processed or to be processed, whereby the control of the media content processing device can be greatly simplified.

Media content processing devices are generally able to carry out numerous control sequences. The greater the number of possible control sequences, the more complex is the control of such a media content processing device. The invention allows use of knowledge of the media content to be processed pertaining to its content type to determine in advance which of all possible control sequences would be most suitable for dealing with this type of content. Control of the :media content processing device based on the remaining control sequence(s) is therefore made simpler for the user. According to the invention, selection of the permitted control sequence(s) can be effected, in particular, by configuration of the appropriate control parameter.

Furthermore, the invention allows that complex algorithms used in control of the content rendering device be greatly simplified with the aid of content descriptors, comprising information, present already in the media content, about the content type, as additional or supplementary information for control of the media content processing device. This simplification means that complex hardware—for example less processing power or less memory—is required in order to attain a satisfactory interaction between user and content rendering device.

The term “content descriptor” covers all information suitable for describing a media content, e.g.:

names of actors, newscasters, presenters, talk-show guests;

voices of actors, newscasters, presenters, talk-show guests;

languages of actors, newscasters, presenters, talk-show guests;

topics of documentaries, political discussions, sports shows;

the topicality or year of production of a broadcast content;

key-words or images present in a broadcast content;

title of a documentary, movie, political discussion, or sports show;

specific program descriptions, e.g. soccer match, rock music show etc.;
program details, e.g. movie with Julia Roberts, news show with Dianne Sawyer etc.;
genre of the content (sports, news, movie, music show, jazz, 50s movie etc).

Adjustment of a device control parameter depending on a content descriptor can take place in practice via directly interpretable rules or via algorithms that have to be computationally evaluated.

Preferably, the media content to be processed or stored comprises a number of content descriptors, preferably determined or identified upon receiving or accessing the media content. Content descriptors can for example be supplied along with the media content by a provider such as a television broadcast provider. Equally, the content descriptor can for example be broadcast to the media content processing device by a service provider, whereby the content descriptors are unambiguously assigned to the appropriate media content.

Additionally or alternatively, a content descriptor can be entered by a user into the media content processing device, for example by means of a user interface. A user, when programming his video recorder to specify start time, date and channel, can for example enter supplementary information about the content type in the form of a content descriptor. This can be done by a menu-controlled selection of one of a number of content descriptors predefined by the video-recorder, or the user can enter a content descriptor himself.

The content descriptor thus entered can alternatively or additionally be based on an electronic programming guide where the programs are classified according to content type, e.g. NexTView.

In a particularly preferred embodiment, a content descriptor is extracted from the media content using known methods of analysis. For example, keywords can be extracted from the media content using methods of speech recognition, or specific voices can be identified in the media content by the use of speaker identification methods.

The media content processing device preferably comprises a content rendering device or is itself a content rendering device such as, for example, a television, where the device control parameter controls the content rendering. Here, rendering of a content means presenting video content as video images on the screen, or converting audio content to audible sound.

The device control parameter preferably controls the volume of the content rendering device, such as the volume of a television set. For example, the volume might be made louder for a sports program to create a stadium atmosphere, quieter for music programs to avoid disturbing any neighbours; louder for movies that feature a lot of dialogue; quieter for action movies or action scenes with loud, possibly irritating, sound effects such as explosions or collisions accompanied by loud music soundtracks.

In a particularly preferred embodiment, a function unit, for example a user interface or an automatic speech or speaker recognition unit, of the content processing device is configured with the aid of the device control parameter. The reaction (or behaviour) of this function unit in response to specific input parameters, in particular the output of output parameters or combinations of output parameters as a function of input parameters or combinations of input parameters, can thus be influenced by the configuration of this function unit. In this way the output parameters of the function unit are “indirectly” controlled by the control parameters based on the content descriptors.

This function unit preferably comprises a user interface or is part of a user interface, so that the device control parameter, by configuring the appropriate control unit, controls the interaction between the user and the content rendering device.

For example, the functionality of the off-switch of the television device may be adapted to the content type—during a ‘normal’ program, the television device will immediately switch off when the off-switch is being pressed, however, when the off-switch is pressed during a news program, the television device will stay on until the end of the news program, when it will automatically switch off. The user may define the desired reaction of the television device to the off-switch depending on the different content types.

In a further preferred embodiment of the invention, the type of program defines the output modality that the system or the systems' user interface uses to interact with the user. During a video oriented program (e.g. sports, action movie), the system chooses to interact with the user via audio signals (sounds or speech synthesis) in order not to interrupt the more important video part. During an audio oriented program (e.g news, comedy), the system may choose to interact with the user via video output (on-screen display) in order not to interrupt the more important audio part.

In a particularly preferred embodiment of the invention, the device control parameter controls the reaction of a content rendering device to remote control commands. This embodiment is equivalent to a solution whereby a device control parameter controls the association of the buttons on a remote control with functions of a media content processing device, i.e. it configures the way in which the media content processing device is remotely controlled, so that this embodiment also lies within the scope of the invention.

In the following, three preferred examples for the content type dependent reaction of a television device to remote control commands are described:
Audio information might suffice during a news program. Therefore, switching channels only results in switching the video, while the audio still stays on the news channel. This enables browsing the other channels while still being informed about the news.
Video information might be sufficient during a sports program.

Therefore, switching channels only results in switching the audio, while the video still stays on the sports channel. This enables browsing the other channels while still having all the information about the ongoing game. (Another alternative for sports programs is to automatically activate the ‘picture-in-picture’ function, when channels are being switched.)
A ‘context’ button activates the provision of additional information.

The type of additional information depends on the type of the content being watched. For a news program, the ‘context’ button results in additional background about the current news item. During a movie, the ‘context’ button provides information about the actors. During a sports program, the ‘context’ button provides updated information about other ongoing games.

In an equally preferred embodiment of the invention, the function unit configured by the associated device control parameters comprises a speech recognition device or a speaker identification device or is part of a speech recognition device or a speaker identification device, so that the device control parameter ultimately controls a speech recognition method or a speaker identification method. The device control parameter can, for example, define a speech recognition vocabulary or a speech recognition grammar. By adapting the configuration of the speech recognition device or a speaker identification device to the current media content being processed, a speech recognition method or a speaker identification method can be carried out in a more effective manner, i.e. even a relatively simple hardware configuration can attain good recognition performance.

In preferred embodiments of the invention, the device control parameters, in addition to or as an alternative to recognition vocabulary or recognition grammar, determine one or more of the following characteristics of speech recognition or speaker recognition methods:
Speech understanding grammar
Dialogue description (for interaction between the user and the device)
Acoustic models for the speech recognizer
Language models for the speech recognizer
Pruning thresholds (for the speech recognition decoding process)
Confidence thresholds (for the decision making process within the device)

The speech recognition process or the speaker identification process can be applied to search the audio information of the current media content to be processed for keywords, or for pre-determined speakers, and to further process the appropriately categorised content, for example by storing the appropriately categorised media content.

A media content processing device according to the present invention comprises a content descriptor detection arrangement, configured in such a way as to detect whether a media content to be processed is described by a predefined content descriptor or by several predefined content descriptors. A control unit is configured such that a device control parameter is adjusted, depending on the content descriptor that describes the media content to be processed. A control of the media content processing device is carried out in accordance with this device control parameter.

The content descriptor detection arrangement can be realised as a content analysis unit, which extracts one or more content descriptors from the media content to be processed, or can be part of a receiver or storage access device, or may work together with a receiver or memory access device that can detect a content descriptor associated with the media content, for example as an accompanying signal. The content descriptor detection arrangement can however also operate in conjunction with a user interface or can part of a user interface that converts user input into corresponding content descriptors.

Other objects and features of the present invention will become apparent from the following detailed descriptions considered in conjunction with the accompanying drawing. It is to be understood, however, that the drawings are designed solely for the purposes of illustration and not as a definition of the limits of the invention.

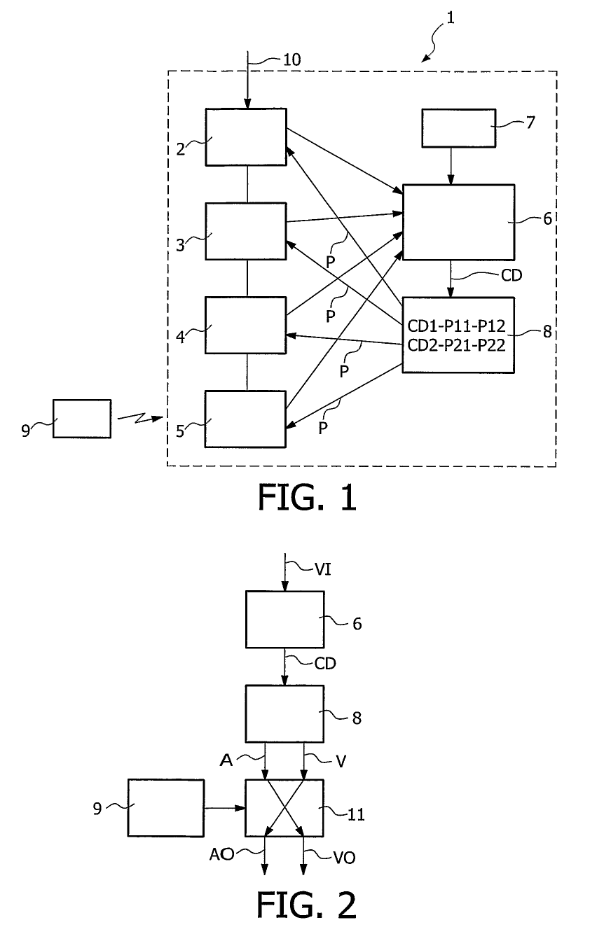

FIG. 1 is a block diagram of the system architecture of a content processing device with a remote control module;

FIG. 2 is a process sequence of a method for controlling a content processing device.

The individual components of a media content processing device 1 are described in more detail with the aid of the figures, as well as the steps of an exemplary method for controlling a media content processing device 1.

For the sake of clarity, only those components of a media content processing device 1 necessary for an understanding of the invention are shown in the figures. It goes without saying that a media content processing device 1 also comprises any components that are usually found in such processing systems, for example any necessary cables or connections, processors, power supplies, switching elements or bus systems.

FIG. 1 shows a media content processing device 1, such as an intelligent home entertainment center, and, belonging thereto, a remote control 9 with a suitable interface, e.g. An intra-red interface.

The media content processing device 1 shown in FIG. 1 incorporates a receiver arrangement 2, constructed in a way suitable for receiving media contents incoming via a broadcast channel 10.

The speaker recognition device or the speech recognition device 3, which can be realised by means of a programmable processor, is able to recognise predefined keywords or specific voices in the received media content.

A content storage unit 4, realised e.g. in the form of a hard-disk, can be used to store media contents, perhaps according to pre-defined rules.

The content rendering device 5 can comprise a display unit or loudspeaker arrangement for rendering or replaying received or stored media contents.

The components 2, 3, 4, 5 of the media content processing device 1 thus briefly described are connected in some way to a content descriptor detection unit 6, comprising a programmable processor. This is configured or constructed for the detection of content descriptors which describe the media content currently being processed. The content descriptors are extracted using suitable analysis methods from the media content, from a signal accompanying the received signal, or from information input by the user via the user interface 7.

According to one realisation, the speech recognition device or speaker recognition device 3, as part of the content descriptor detection unit 6, can be applied to extract content descriptors such as key-words or speaker voices from the media content being processed.

The content descriptor(s) CD, detected by the content descriptor detection unit 6 and describing the current media content to be processed, are forwarded to a control unit 8. The control unit 8, which might also be realised as a programmable processor, controls the media content processing device 1, various components 2, 3, 4, 5 of the media content processing device 1 and the interaction between these components 2, 3, 4, 5.

For example, in a memory unit, being a component of the control unit 8 and not shown in the figure, associations between content descriptors CD1, CD2 and values of various control parameters P11, P12, P21, P22 are stored. The detected content descriptors(s) CD are converted according to these associations to the appropriate control parameter P or control parameters in the control unit 8.

The control parameter P or derived control signals are then forwarded by the control unit 8 to the components 2, 3, 4, 5 described above, in order to control the components 2, 3, 4, 5 of the media content processing device 1, thereby controlling the media content processing device 1.

The approach thus described allows, for instance, the following applications:
Control of a speech recognition device 3 in accordance with the media content to be processed: depending on which content descriptors are detected, control parameters are adjusted for the speech recognition device 3, such as, for example, pruning thresholds, so that the speech recognition device is configured in accordance with the content type. The media content to be processed can either be received by the receiver arrangement 2, or read from the content storage unit 4.
Control of a content storage unit 4 in accordance with the media content to be processed: depending on which content descriptors are detected, control parameters are adjusted to control the content storage unit 4.
Control of a content rendering device 5 in accordance with the media content to be processed: depending on which content descriptors are detected, control parameters are adjusted for the content rendering device 5, such as to directly control the volume level or to configure an appropriate function unit of the device 5 to influence the reaction of the content rendering device 5 to the remote control device 9.

The media content processing device 1 can be realised as part of a stand-alone device in the vicinity of the user, or may be distributed so that for example the receiver arrangement 2, the speech recognition device 3 or the speaker recognition device 3 and the content storage unit are realised as network elements of a broadcast provider or other provider, and the content rendering device 5 is located in the vicinity of the user. The individual components 2, 3, 4, 5, 6, 7 of the media content processing device 1 can each comprise a number of processors, or can share one or more processors.

FIG. 2 shows a flow chart of a method for content type controlled interaction between a media content processing device 1 and a user.

In a first step, a media content detection arrangement 6 detects content descriptors CD for determination whether an audio/video input VI, such as a movie or news program, is predominantly video-based or predominantly audio-based, i.e. whether the media content itself avails of predominantly video information (e.g. sports program, action movie) or predominantly audio information (e.g. news program, comedy show) in conveying information. The content descriptors CD are sent to a control unit.

Depending on whether the media content is video-based or audio-based, the control unit 8 sends control parameters A, V to an information output rendering module 11 of, for example, a TV device.

The user now requests the output of information which he requires—for example, for programming the media content processing device 1—from the media content processing device 1 via a user interface, comprising a remote control 9. The information output rendering module 11 or another function unit (not shown), being the internal part of the user interface, is configured based on the control parameters A, V. In this way, the presence of a predominantly audio-based content results in a video-based output VO of the requested information by means of, for example, the TV screen, while the audio part of the incoming media content is further presented to the user without undergoing any interruption. The presence of a predominantly video-based media content results in an audio-based output AO of the requested information over the loudspeaker arrangement of the TV device, while the video part of the incoming media content is further presented to the user without undergoing any interruption.

In such an example, the user can also continue to watch a sports show broadcast on one channel, not missing any of the action, whilst listening to the news broadcast on an other channel.

The example described above can be realised in practice also in such a way that the content descriptor detection unit 6 forwards the detected content descriptors directly to the output rendering module 11, which encompasses an appropriate control unit. The content descriptors are then converted to appropriate control parameters in the control unit. The control parameters in turn control the output rendering module 11 in such a way that the information requested by the user is rendered by adaptation to the media content currently being processed or rendered.

Although the present invention has been disclosed in the form of preferred embodiments and variations thereon, it will be understood that numerous additional modifications and variations could be made thereto by a person skilled in the art, without departing from the scope of the invention. For example, the content processing device 1 may comprise only one of the components 2, 3, 4, 5 described, or any combination of the components 2, 3, 4, 5 described. Also, the content processing device 1 might be incorporated partially or entirely in a personal computer.

For the sake of clarity, it is also to be understood that the use of “a” or “an” throughout this application does not exclude a plurality, and “comprising” does not exclude other steps or elements. A “unit” or “module” may comprise a number of blocks or devices, unless explicitly described as a single entity. The term “hardware” can mean digital or analogue hardware, and might mean any type of circuitry such as boards, integrated circuits, off-the-shelf modules, custom modules etc.

1. A method for controlling a media content processing device, comprising:
pre-defining a plurality of content descriptors;
determining whether a media content to be processed is described by a pre-defined content descriptor;
automatically adjusting a device control parameter based on the content descriptor which describes the media content to be processed; and
automatically controlling the media content processing device based on the device control parameter.

2. The method according to claim 1, wherein the content descriptor is entered by a user.

3. The method according to claim 1, wherein the media content comprises, as an accompanying signal, the content descriptor describing the media content to be processed.

4. The method according to claim 1, wherein the content descriptor is extracted from the media content to be processed.

5. The method according to claim 1, wherein the media content processing device comprises a content rendering device, and the device control parameter controls the content rendering.

6. The method according to claim 5, wherein the device control parameter controls the volume of the content rendering device.

7. The method according to claim 1, wherein the device control parameter configures a function unit of the media content processing device to control the reaction of this function unit in response to specific input parameters.

8. The method according to claim 7, wherein the function unit comprises a user interface, and the device control parameter controls the interaction between the user and the media content processing device.

9. The method according to claim 8, wherein the device control parameter controls the response of the media content processing device to remote control commands.

10. The method according to claim 7, wherein the function unit comprises at least one of a speech recognition device and a speaker identification device, and the device control parameter controls a speech recognition process or a speaker identification process.

11. The method according to claim 1, wherein the relationship between device control parameter and content descriptor can be configured by the user.

12. A media content processing device, comprising:
a content descriptor detection arrangement configured for determining whether a media content to be processed is described by a predefined content descriptor of a plurality of predefined content descriptors;
a control unit configured such that a device control parameter is adjusted based on the content descriptor describing the media content to be processed, and the media content processing device is automatically controlled based on the device control parameter.
